(19) United States
(12) Patent Application Publication
(10) Pub. No.: US 2003/0103260 A1
(43) Pub. Date: Jun. 5, 2003

(54) Optical fiber amplifier using two-port wavelength selective coupler

(76) Inventors: Sung Jun Kim, Kyunggi-do (KR); Jeong Mee Kim, Kyunggi-do (KR); Rae Sung Jung, Kyunggi-do (KR)

Correspondence Address: Marger Johnson & McCollom, 1030 S W Morrison Street, Portland, OR, 97205, US

(21) Appl. No.: 10/030,874

(22) PCT Filed: Feb. 21, 2001
(86) PCT No.: PCT/KR01/00256

(30) Foreign Application Priority Data
Feb. 21, 2000 (KR) 2000-8215

(51) Int. Cl. H04B 10/12

(52) U.S. Cl. 359/341.1

(57) ABSTRACT

An optical fiber amplifier having higher gain and lower noise than a prior art fiber amplifier when both amplifiers employ an equal length of gain medium-containing optical fiber and an equal intensity of pumping light. The optical fiber amplifier of the present invention comprises: a length of optical fiber containing a gain medium; a circulator, connected to one end of the optical fiber, that introduces optical signals into the optical fiber and outputs the optical signals amplified at the optical fiber to its output port; optical pumping means, connected to the other end of the optical fiber, for applying pumping light to the optical fiber in order to amplify the introduced optical signals; and a two-port wavelength selective coupler, disposed between the other end of the optical fiber and the optical pumping means, that passes pumping light from the optical pumping means and reflects back the amplified optical signals from the optical fiber. According to the present invention, a high-efficiency optical fiber amplifier can be manufactured with low costs. Moreover, when the fiber amplifier of the present invention is used for an optical transmitter system, system characteristics such as optical signal-to-noise ratio and system margin can be enhanced.

### TECHNICAL FIELD

The present invention relates to an optical fiber amplifier, especially to an optical fiber amplifier having higher gain and lower noise than a prior art optical fiber amplifier when both amplifiers employ an equal length of gain medium-containing optical fiber and an equal intensity of pumping light.

### BACKGROUND ART

Generally, in an optical transmitter system for long distance optical communication, a prior art optical communication method employs laser diode that is converting an electric signal to an optical signal, transmitting the converted optical signal through optical fiber, converting the optical signal that is weakened by the loss of optical fiber when it was transmitted through the optical fiber to electric signal and amplifying, and then converting it back to optical signal. There have been many problems in this type of method such as low output of optical transmitter, enlargement of transmitting amplifier system, replacement of transmitter depending on the speed of the transmitter, and limit on the transmitting distance due to low output of the optical transmitter. To overcome these problems and perform efficient optical amplification, an optical amplifier that amplifies optical signal itself has been required.

Erbium Doped Fiber Amplifier (EDFA hereinafter) is spotlighted as such an optical amplifier and a core module for optical communication. The EDFA is used to periodically amplify the optical signal when a large sum of data is transmitted long distance through a single strand of optical fiber to compensate the decay of the optical signal due to long distance transmittance and is used for Wavelength Division Multiplexing (WDM) method that simultaneously amplifies optical signal of various wavelengths. Therefore, explanation of the prior art of this invention will be focused on EDFA.

FIG. 1 is an outlining block diagram of usual general single forward EDFA. Here, EDFA is composed of an Erbium Doping optical Fiber (EDF hereinafter) 120, a pump laser diode 100 as an optical source to excite Erbium ion in its ground state in EDF, a Wavelength Selective Coupler (WSC hereafter) 110 to couple signaling light with pumping light of different wavelengths and make them being introduced as a single line, and an isolator 130 132 to block the reverse direction progress of the optical signal. WSC 110 couples signal light that passes input isolator 130 with pumping light that comes from pump laser diode 100 as a single optical fiber and makes it being introduced to EDF 120. In WSC for EDFA, there are fused type that is made by anastomosis of multiple numbers of optical fibers and micro-optic type that uses coating of the materials with selective characteristics toward light on glass board and uses light collection technique. An input port isolator 130 is used to prevent Amplified Spontaneous Emission (ASE) from EDF 120 from going out to optical input part. And output port Isolator 132 at the back of the EDF 120 is to prevent the decline of an amplifying efficiency of EDFA due to ASE and amplified signaling light by being re-introduced to EDF 120 after it is reflected from light element such as signal output connector.

On the other hand, the most important factor to affect the performance of an optical amplifier is gain and noise figure. These are related to the intensity of signaling light input to light amplifier, intensity of pumping light, length of EDF, coupling efficiency of WSC to couple signaling light with pumping light. Especially WDM transmittance requires more gain and less noise figure to amplify multiple optical signal, and EDFA with gain levelness with identical gain quality of multiple optical signal. Pump laser diode with high pumping light output, more EDF, and highly efficient WSC are needed to obtain high gain and low noise figure. However elements with these qualities are very high-priced and realization of EDFA that satisfies these required criteria as proper element is necessary.

### DISCLOSURE OF THE INVENTION

Therefore, the present invention is devised to solve the problems stated above and it is an object of this invention to provide an optical fiber amplifier that is superior to the prior art in qualities including gain and noise figure even though identical DEF length is used.

In order to achieve the above object, the optical fiber amplifier of the present invention comprises: a length of optical fiber containing a gain medium; a circulator, connected to one of the optical fiber, that introduces optical signals into the optical fiber and outputs the optical signals amplified at the optical fiber to its output port; optical pumping means, connected to the other end of the optical fiber, for applying pumping light to the optical fiber in order to amplify the introduced optical signals; and a two-port wavelength selective coupler, disposed between the other end of the optical fiber and the optical pumping means, that passes pumping light from the optical pumping means and reflects back the amplified optical signals from the optical fiber.

In the present invention, Erbium doped optical fiber can be used as an optical fiber by choosing Erbium as gain medium.

Meanwhile, it is desirable that laser diode is adopted as an optical pumping means and it is more desirable that the laser diode described above generates pumping light with wavelength ranges between 980 nm and 1480 nm.

Meanwhile, for a two-port wavelength selective coupler described above, it is desirable to equip reflection filter that reflects the light with wavelength ranges of signaling light and passes the light with wavelength ranges of pumping light and an input-output collimator located at both ends of the reflection filter.

### BRIEF DESCRIPTION OF THE ATTACHED DRAWINGS

FIG. 1 is a schematic diagram of usual general single forward Erbium Doped Fiber Amplifier.

FIG. 2 is a schematic block diagram of optical fiber amplifier according to the present invention.

FIG. 3 is a drawing of the structure of a two-port wavelength selective coupler that is used in optical fiber amplifier.

### BEST MODE FOR CARRYING OUT THE INVENTION

Explanation on an example of the present invention referring to the attached drawings is as follows. FIG. 2 is an outlining block diagram of optical fiber amplifier according to the present invention, and this optical fiber amplifier is composed of a pump laser diode 200, EDF 220, circulator 240, and two-port WSC 210. Pump laser diode 220 applies pumping light to EDF 220 in order to amplify the introduced optical signals and generates pumping light with wavelength ranges between 980 nm and 1480 nm. EDF 220 is an amplification medium that amplifies signaling light applied from the circulator 240 by pumping light of the pump laser diode 200. Circulator 240 proceeds optical signal applied from its input port 242 to EDF 220, and amplified optical signal applied from EDF 220 to circulator 240 blocks its generation to the input port 501 and only proceeds to the output port 244. Also, circulator 240 prevents the counter-flow of the light reflected from optical connector that is usually located at the end of the output port 244 to EDF 220. Two-port WSC 210 passes pumping light applied from the pump laser diode 200 to EDF 300 and reflects the amplified signaling light applied through EDF 200 from circulator 240.

Based on the composition described above, an operation of optical fiber amplifier of the present invention will be explained as follows.

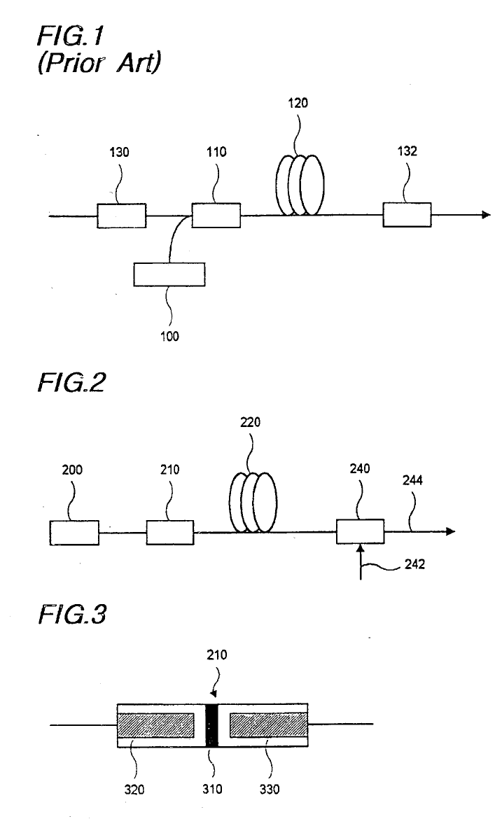

First, an introduced signaling light is applied to EDF 220 through the input port 242 of the circulator 240 and re-introduced to EDF 220 after it is reflected at the two-port WSC 210. Pumping light and signaling light is introduced together from pump laser diode 200 through two-port WSC 210 to EDF 220, and the pumping light applied EDF 220 becomes amplification medium and amplifies the signaling light applied from the circulator 240 to EDF 220. This amplification process is a process where pumping light and signaling light proceed to the reverse direction to each other and the signaling light is amplified. Signaling light that is amplified to the reverse direction is re-reflected at the two-port WSC 210, re-applied to an amplification medium, EDF 220, and is re-amplified to forward direction. The two-port WSC 210 reflects the signaling light amplified at EDF and simultaneously passes the pumping light from pump laser diode 200, therefore, plays the role to couple signaling light with pumping light, resulting in a single optical fiber. In the example described above, the two-port WSC 210 is used to substitute the usual three-port WSC that couples the pumping light with signaling light and the structure of this two-port WSC 210 is described in FIG. 3. Referring to FIG. 3, the two-port WSC 210 is composed of reflection filter 310, input port collimator 320 located at both ends of the reflection filter, and output collimator 330. Reflection filter 310 is a thin film micro-optic element that is composed of two-port, reflects the signaling light region of 1500 nm and passes the pumping light region. Insertion loss of the two-port WSC 210 toward the wavelength of pumping light is smaller than the usual WSC 110 described in FIG. 1, therefore stronger pumping light is applied to EDF 220.

Back to optical fiber amplifier described in FIG. 2, optical signal reflected at reflection filter of the two-port WSC 210 is re-applied to EDF 220, an amplification medium, and is then amplified. This amplification process is a process where pumping light and signaling light proceed to the same direction with each other and amplified signaling light is again amplified. Signaling light amplified in the forward direction goes through the circulator 240 and then proceeds to its output port 244. As described above, the original signaling light applied to EDFA 220 is amplified while proceeding to and from EDF 220, and higher gain than that of the prior art is obtained since stronger pumping light is applied to EDF 220 due to a smaller insertion loss toward the pumping light wavelength of the reflection filter 310 inside two-port WSC 210. Again, it is possible to obtain the equal gain even though shorter EDF or weaker pumping light is used. Therefore, a highly efficient optical fiber amplifier can be manufactured at low costs.

Two-port WSC used in optical fiber amplifier of this invention has advantages as follows. First, due to smaller insertion loss toward wavelength of pumping light than three-port WSC, stronger pumping light can be applied to amplifying optical fiber increasing amplification gain of the optical signal and noise quality of the optical fiber amplifier is enhanced by reducing the elements in the front port of the amplifying optical fiber. Second, system characteristics such as optical signal-to-noise ratio and system margin can be enhanced when the fiber amplifier of the present invention is used for an optical transmitter system since polarized light dependent loss is small.

Meanwhile, due to a newly composed optical fiber amplifier of the present invention, the following effects can be generated. First, quality of the optical fiber amplifier is enhanced since gain rate of the signaling light is increased and noise is reduced owing that amplification of the signaling light is a result of the double trip within amplifying optical fiber. Second, a low-cost optical fiber amplifier can be manufactured since higher amplification gain and lower noise is obtained for equal intensity of the pumping light. Third, a low-cost optical fiber amplifier can be manufactured, if it is aimed for the identical amplification gain, since shorter optical fiber can be used. Fourth, a smaller as well as low-cost optical fiber amplifier can be manufactured since the number of elements that comprises optical fiber amplifier can be reduced.

Embodiments of the present invention are not limited only to the above, and it is evident that it can be diversely modified by a person who has ordinary knowledge in the appropriate field, within the technical idea of the present invention.

### INDUSTRIAL APPLICATION

Optical fiber amplifier of the present invention can be applied to a field such as optical transmitter system for long distance optical communication.

What is claimed:

1. An optical fiber amplifier comprising; a length of optical fiber containing a gain medium; a circulator, connected to one of the optical fiber, that introduces optical signals into the optical fiber and outputs the optical signals amplified at the optical fiber to its output port;
optical pumping means, connected to the other end of the optical fiber, for applying pumping light to the optical fiber in order to amplify the introduced optical signals; and
a two-port wavelength selective coupler, disposed between the other end of the optical fiber and the optical pumping means, that passes pumping light from the optical pumping means and reflects back the amplified optical signals from the optical fiber.

2. The optical fiber amplifier of claim 1, wherein the gain medium is Erbium, and the optical fiber is Erbium doped optical fiber.

3. The optical fiber amplifier of claim 1, wherein the optical pumping means is a laser diode.

4. The optical fiber amplifier of claim 3, wherein the laser diode generates pumping light with wavelength ranges between 980 nm and 1480 nm.

5. The optical fiber amplifier of claim 1, wherein the two-port wavelength selective coupler comprises; a reflection filter that reflects the light with wavelength ranges of signaling light and passes the light with wavelength ranges of pumping light; and an input-output collimator located at both ends of the reflection filter.
